(19) United States
(12) Patent Application Publication
(10) Pub. No.: US 2024/0066962 A1
(43) Pub. Date: Feb. 29, 2024

(54) TILTING TYPE VEHICLE TRUNK DOOR

(71) Applicant: DAEHAN SOLUTION CO., LTD, Incheon (KR)

(72) Inventors: Choong HO KWON, Seoul (KR); Moon-Sik JEONG, Incheon (KR)

(73) Assignee: DAEHAN SOLUTION CO., LTD, Incheon (KR)

(21) Appl. No.: 18/224,104

(22) Filed: Jul. 20, 2023

(30) Foreign Application Priority Data
Aug. 25, 2022 (KR) 10-2022-0106554

(51) Int. Cl. B60J 5/10

(52) U.S. Cl. CPC B60J 5/107

(57) ABSTRACT

A trunk door is divided into two sub-doors to be folded in two steps. Even when it is difficult to open the trunk door due to a small distance between a vehicle and a wall, the trunk door can be easily and conveniently opened or closed. The sub-doors are formed to rotate in the same direction or rotate in the different directions. A length of a rotation radius along which the trunk door rotates is reduced. Thus, the trunk door can be conveniently opened or closed even in a small space. When there is a risk of coming into contact with the wall, since the outer sub-door is rotated in a backward direction to reduce a total rotation radius of the trunk door, the sub-door does not come into contact with the wall. Thus, the trunk door can be easily and conveniently opened or closed.

### CROSS-REFERENCE TO RELATED APPLICATION

This application claims priority to and the benefit of Korean Patent Application No. 10-2022-0106554, filed on Aug. 25, 2022, the disclosure of which is incorporated herein by reference in its entirety.

### BACKGROUND OF THE INVENTION

### 1. Field of the Invention

The present invention relates to a tilting type vehicle trunk door, and more specifically, to a tilting type vehicle trunk door formed to be folded in two steps so that, in a state in which a vehicle is positioned close to a wall or the like and a trunk door cannot be opened due to the wall or the like being in contact therewith when the trunk door is attempted to be opened, the trunk door is opened or closed in a two-axis turning manner and used conveniently.

### 2. Discussion of Related Art

In general, as shown in FIGS. 1 and 2, there are vehicles in which rear seats and trunks are adjacent to efficiently use interior spaces. In particular, in this type of vehicle, a trunk door (or tailgate) D is installed to be opened by turning upward from below. Accordingly, in order to easily open the trunk door, that is opened upward, and stably maintain the open state, the trunk door is opened or closed in various manners as described in the following Patent Document 1 to Patent Document 3.

(Patent Document 1) Korean Laid-Open Patent No. 10-2007-0062305

An apparatus for opening and closing a tailgate for an automobile provides an operating force for opening or closing a tailgate installed at a rear of an automobile and includes a cylinder body having a high-pressure cylinder part and a low-pressure cylinder part, first and second pistons slidably installed in the high-pressure cylinder part and the low-pressure cylinder part, respectively, to compress gas filling the high-pressure cylinder part and the low-pressure cylinder part, and first and second rods installed on the first and second portions and having end portions installed on the tailgate and a vehicle body.

(Patent Document 2) Korean Laid-Open Patent No. 10-2017-0042083

A tailgate which opens or closes a rear of a vehicle body includes a hinge bracket having a main hinge mounted on one side of the tailgate and fixed to the vehicle body so that the tailgate rotates vertically, a hinge shaft formed at a position corresponding to the main hinge, and a fixing pin mounted on the main hinge, a fixing bracket fixedly coupled to the hinged bracket, a rotating bracket rotatably mounted on the fixing bracket, a rotating link of which one end is connected to the fixing pin mounted on the main hinge at a position spaced apart from the hinge shaft and the other end is connected to one end of the rotating bracket, and a telescopic device of which a length extends to be connected to the other end of the rotating bracket to rotate the rotating bracket, and an opening and closing structure of the tailgate is provided, wherein a rotating force opening the tailgate is generated at the hinge shaft by a force of the rotating link pressing the fixing pin according to the extension of the telescopic device. According to the opening and closing structure of the tailgate, since the tailgate is not exposed, a trunk, that is, a rear space, can be sufficiently secured, and thus the convenience of an occupant or driver can be provided, and there is also an effect of increasing a space. In addition, even when the rear space of the vehicle is small, since the tailgate is not exposed, there is an effect of improving aesthetics when viewed from the outside.

(Patent Document 3) Korean Laid-Open Patent No. 10-2009-0043127

The patent relates to an apparatus for opening and closing a tailgate for a vehicle, and to an apparatus for opening and closing a tailgate for a vehicle, in which the tailgate is divided into an upper portion and a lower portion based on a rear combination lamp and a rear glass so that the tailgate is easily opened, the feeling of opening is excellent, and the tailgate is opened by a little force even when a rear space is small. In the tailgate which is coupled to a rear roof panel of the vehicle using a hinge, the tailgate is divided into upper and lower tailgates, and the upper and lower tailgates are opened or closed by a rotating device installed between the upper tailgate and the lower tailgate. When the tailgate is closed, a two-axis opening and closing apparatus including a link, which connects the upper portion and the lower portion, and a gas lift is not exposed to the outside, a hinge of a vehicle body and a hinge of an upper link of the tailgate are connected using a chain, and thus two-axis opening and closing operations are in conjunction with each other. Accordingly, when the tailgate is opened, since a distance from the hinge of the vehicle body to an end the tailgate is reduced, a force necessary for opening or closing the tailgate is reduced, the feeling of opening is improved, and thus a tall cargo can be loaded. Since a lower end portion is folded on an upper end portion to reduce a space when the tailgate is completely opened, the tailgate can be opened even when a space behind the vehicle is insufficient. In addition, since only the lower tailgate may be operated through sliding movement using a transfer lever of a center shaft of the upper tailgate, there is a unique effect of simply opening the lower portion of the tailgate and loading a cargo as necessary.

As shown in FIGS. 1 and 2, such a trunk door D is installed in a vehicle to be opened up and down, and when the trunk door D is opened, a lower portion of the trunk door D is moved outward from a vehicle body.

### RELATED ART

### Patent Documents

(Patent Document 1) Korean Laid-open Patent No. 10-2007-0062305 (Publication Date: Jun. 15, 2007)
(Patent Document 2) Korean Laid-open Patent No. 10-2017-0042083 (Publication Date: Apr. 18, 2017)
(Patent Document 3) Korean Laid-open Patent No. 10-2009-0043127 (Publication date: May 6, 2009)

However, as shown in FIGS. 2 and 3, a trunk door D which is rotated and opened upward from below around an axis which is a rotating center has the following problems when a wall or obstacle is present behind a vehicle.

(1) When a trunk door comes into contact with a wall or obstacle and is not completely opened, there is an inconvenience that movement is uncomfortable when a cargo is loaded in a trunk or a loaded cargo is unloaded from the trunk.

(2) Accordingly, when a vehicle is parked or stopped, there is a trouble of parking or stopping at a distance in consideration of a distance from a wall or obstacle behind the vehicle in order to open or close a trunk door.

(3) In addition, when a vehicle is parked or stopped regardless of a distance from a wall or obstacle, a trunk door cannot be completely opened, and accordingly, there is an inconvenient that the parked or stopped vehicle is moved to be parked or stopped at a sufficient distance from the wall or obstacle.

(4) Meanwhile, when a trunk door is opened without securing such a sufficient distance when a vehicle is parked or stopped, there is a risk that the trunk door comes into contact with a wall or obstacle and is damaged.

### SUMMARY OF THE INVENTION

The present invention is provided in consideration of the above-described points and directed to providing a tilting type vehicle trunk door divided into two sub-doors to be folded in two steps and easily and conveniently opened or closed and used by folding in two steps even when a distance between a vehicle and a wall or the like is not sufficient to open the trunk door.

In this case, the present invention also directed to providing a tilting type vehicle trunk door in which directions, in which two sub-doors rotate, are the same or opposite to each other to reduce a length of a total rotation radius along which the trunk door rotates so as to easily and conveniently open or close the trunk door even in a small space.

In addition, the present invention also directed to providing a tilting type vehicle trunk door in which, when there is a risk of coming into contact with a wall or the like while two sub-doors are opened together, an outer sub-door rotates in an opposite direction to reduce a total rotation radius of the trunk door so that the sub-door does not come into contact with the wall or the like, and a length of the rotation radius of the trunk door is also reduced to easily and conveniently open or close the trunk door.

According to an aspect of the present invention, there is provided a trunk door for a vehicle in a tilting type, which is opened by moving outward from a vehicle body in a wagon, a hatch-back, a van, or a sport utility vehicle (SUV), wherein the trunk door (100) is divided into two parts as first and second sub-doors (100a, 100b) which are rotated, a rotary shaft of the first sub-door (100a) rotatably installed on the vehicle body and a rotary shaft installed between the first sub-door (100a) and the second sub-door (100b) are installed in parallel, and the second sub-door (100b) includes a vehicle door lock and is installed to be rotated about the first sub-door (100a).

The first sub-door (100a) and the second sub-door (100b) may be installed to rotate in the same direction or installed to rotate in directions opposite to each other. The trunk door (100) may be vertically opened or closed in a hatchback manner and operate according to the following order. (1) The first and second sub-doors (100a, 100b) are opened together, (2) only the second sub-door (100b) is turned in a direction opposite to a direction in (1), and then (3) the first and second sub-doors (100a, 100b) are opened in the opening direction in (1).

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a side view illustrating an example of a vehicle on which a trunk door opened or closed in a hatchback type is mounted;

FIG. 2 is a side view illustrating a use state in which the trunk door in FIG. 1 is opened and used;

FIG. 3 is a partial side view illustrating the vehicle in a state in which the trunk door in FIG. 1 comes into contact with a wall or obstacle and cannot be completely opened or closed when attempted to be opened or closed;

FIG. 4 is a partial side view illustrating components of a tilting type vehicle trunk door of a vehicle according to the present invention; and

FIGS. 5 to 7 are partial views illustrating a sequential process of opening or closing the tilting type vehicle trunk door of the vehicle in FIG. 4.

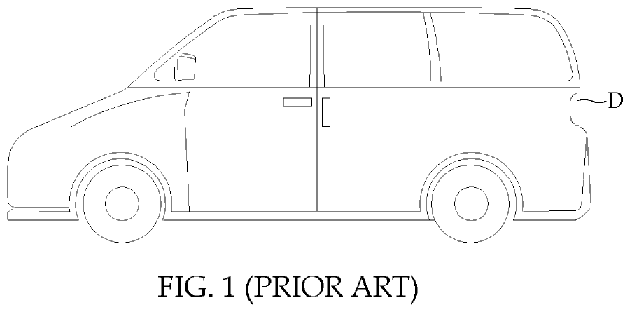

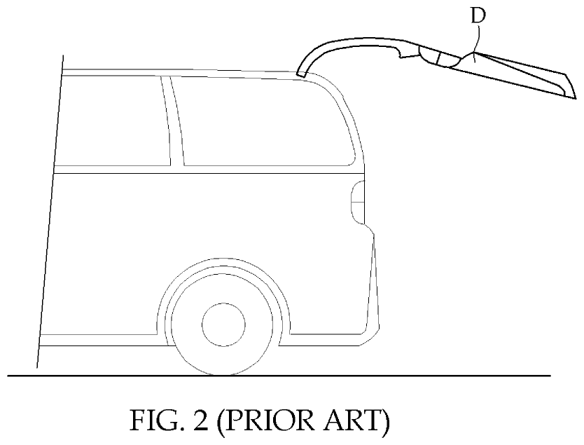

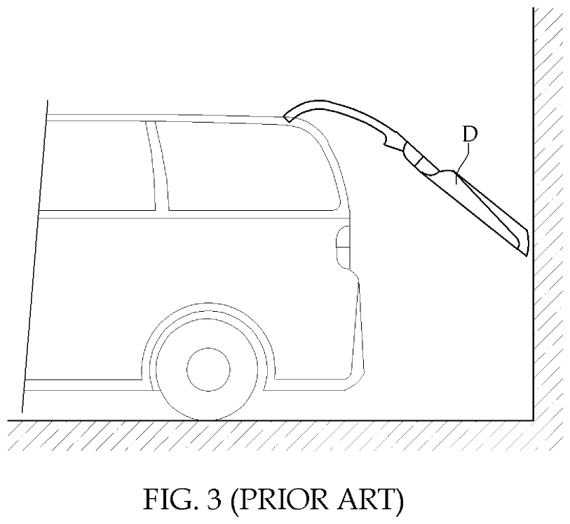

### DETAILED DESCRIPTION OF THE INVENTION

Hereinafter, exemplary embodiments of the present invention will be described in more detail with reference to the accompanying drawings. Moreover, terms and words used in the present specification should not be interpreted as being limited to commonly used meanings or meanings in dictionaries and should be interpreted as having meanings and concepts which are consistent with the technological scope of the invention based on the principle that the inventors have appropriately defined concepts of terms in order to describe the invention in the best way.

Therefore, since the embodiments described in this specification and components illustrated in the drawings are only exemplary embodiments and do not represent the overall technological scope of the invention, it should be understood that there may be various equivalents, modifications substituting the exemplary embodiments at the time of filing of this application.

Structure of Tilting Type Vehicle Trunk Door

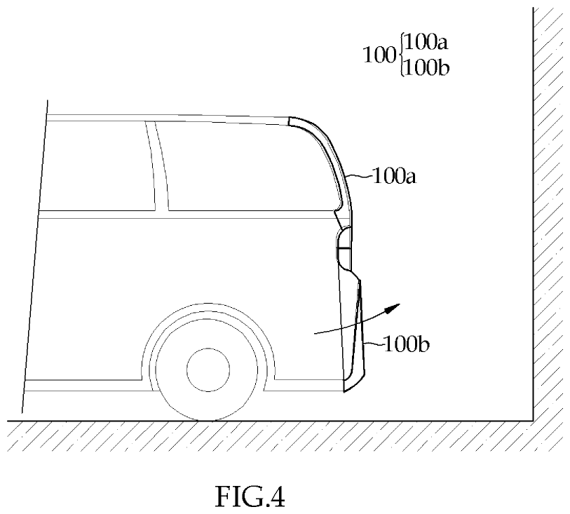

In a tilting type vehicle trunk door according to the present invention, as shown in FIGS. 4 to 7, a trunk door 100 mounted on a rear portion of a vehicle is divided into two first and second sub-doors 100a and 100b and opened or closed.

In this case, as the first and second sub-doors 100a and 100b are formed to rotate in the same direction or different directions around rotation axes in parallel to perform an opening or closing operation, a length of an opening or closing radius of the trunk door 100 may be reduced. Accordingly, even when a distance between the vehicle and a wall or the like is small, the trunk door 100 is easily opened or closed and conveniently used.

In addition, in the trunk door 100, the first sub-door 100a is rotated together with the second sub-door 100b, then the second sub-door 100b is rotated in a direction opposite to the first sub-door 100a, and then the first sub-door 100a is rotated together with the second sub-door 100b in a desired opening direction so that the first and second sub-doors 100a and 100b are rotated without coming into contact with the wall or obstacle and the trunk door 100 is also completely opened or closed and conveniently used.

Hereinafter, such components will be described in more detail with reference to the accompanying drawings as follows.

A. Trunk Door

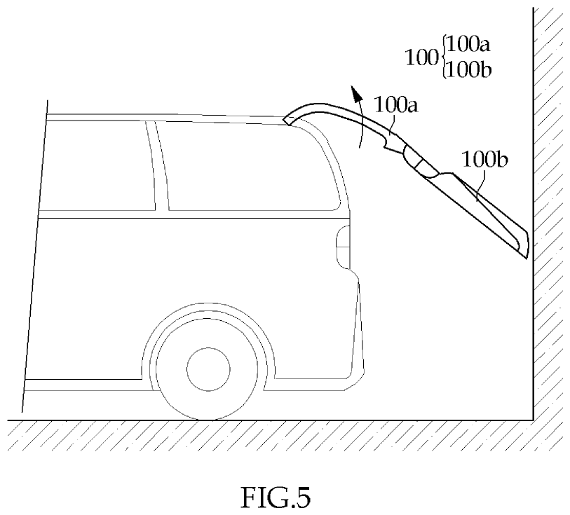

As shown in FIGS. 4 and 5, the trunk door 100 is a door which is turned upward from below around the axis which is the rotation center to be opened. The trunk door 100 is mounted on a wagon, a hatch-back, a van, a sport utility vehicle (SUV), or the like, and when the trunk door 100 is opened, an opening or closing operation is performed while the trunk door 100 is moved outward from a vehicle body.

In the exemplary embodiment of the present invention, as shown in FIGS. 4 and 5, the trunk door 100 is installed so that the divided first and second sub-doors 100a and 100b are rotated sequentially or only any one of the first and second sub-doors 100a and 100b is rotated to perform a tilting operation.

B. First and Second Sub-Doors

As shown in FIGS. 4 and 5, the first and second sub-doors 100a and 100b are formed by dividing the existing trunk door 100. Accordingly, a hinge and the like used for opening or closing the existing trunk door 100 are used in the first sub-door 100a mounted on the vehicle body without change to perform a rotation operation, and the second sub-door 100b is mounted on one edge of the first sub-door 100a (an edge facing an edge rotatably installed on the vehicle body) to be rotated in place.

In this case, a hinge and a lock device used for opening or closing the existing trunk door 100 are used in the first sub-door 100a and the second sub-door 100b, and the second sub-door 100b is rotated about the first sub-door 100a and also maintains an unfolded state of being coupled with the first sub-door 100a.

In addition, as the first sub-door 100a and the second sub-door 100b are installed so that rotary shaft parts are positioned in parallel, as shown in FIGS. 5 to 7, as the first and second sub-doors 100a and 100b are rotated, a length of a rotation radius of the trunk door 100 is reduced, and thus the trunk door 100 can be opened or closed without coming into contact with the wall or the like present behind the vehicle.

Meanwhile, in the exemplary embodiment, the first sub-door 100a and the second sub-door 100b may be mounted to be rotated in the same direction or mounted to be rotated in directions opposite to each other.

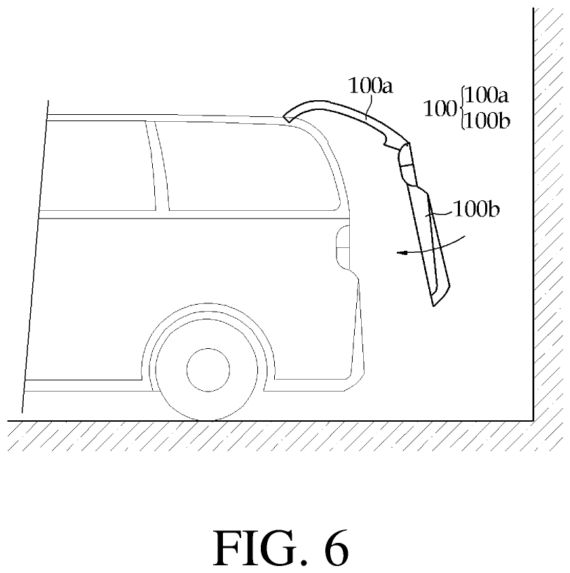

However, in the exemplary embodiment of the present invention, as shown in FIGS. 5 and 6, it is most preferable that the first sub-door 100a and the second sub-door 100b are installed to be rotated in the directions opposite to each other. That is, as shown in FIG. 5, when only the first sub-door 100a is rotated together with the second sub-door 100b, and the trunk door 100 does not come into contact with the wall or the like, the trunk is opened and used by only using the first sub-door 100a.

However, as shown in FIG. 6, when the trunk door 100 comes into contact with the wall or the like while being opened using the first sub-door 100a, the first sub-door 100a is no longer rotated, and then the second sub-door 100b is rotated. In this case, as the second sub-door 100b is rotated in a direction opposite to a rotation direction of the first sub-door 100a, the second sub-door 100b does not come into contract with the wall or the like and the length of the rotation radius is also reduced.

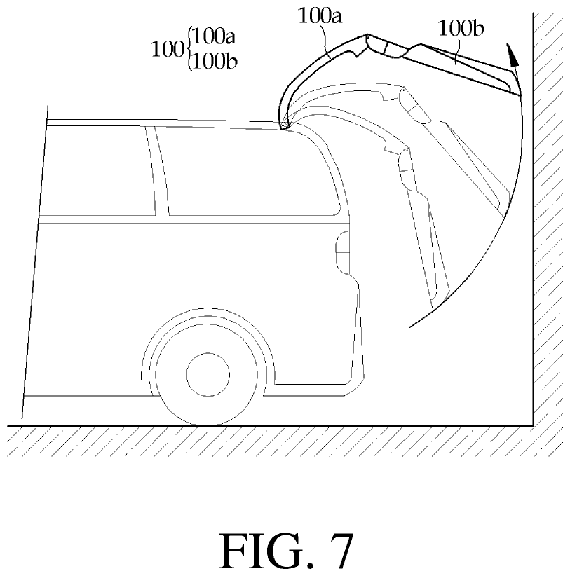

Finally, as illustrated in FIG. 7, the trunk door 100 may be completely opened by rotating only the first sub-door 100a together with the second sub-door 100b.

As described above, in the present invention, as the trunk door is folded in two steps, even when there is an obstacle such as a wall behind the vehicle, and it is difficult to open the trunk door, the trunk door is folded twice to reduce the length of the rotation radius, and thus the trunk door can be easily, conveniently, and completely opened or closed.

A tilting type vehicle trunk door according to the present invention has the following effects.

(1) As a trunk door is divided into two sub-doors and rotated, a length of an opening or closing radius of the trunk door can be reduced when the trunk door is opened or closed.

(2) Accordingly, even when a distance between a rear of a vehicle and a wall or obstacle behind the vehicle is small, a length of an opening or closing radius of a trunk door is reduced, and thus the trunk door can be easily and conveniently opened or closed.

(3) Accordingly, even when a vehicle is parked or stopped without securing a sufficient distance between a rear portion of the vehicle and a wall by mistake, or a sufficient distance cannot be secured, a trunk door can be conveniently opened or closed and used.

(4) A rotation maintaining function of a vehicle door and a lock function of a door can be used in such a tilting type trunk door without change.

What is claimed is:

1. A trunk door for a vehicle in a tilting type, which is configured to be opened by moving outward from a vehicle body in a wagon, a hatch-back, a van, or a sport utility vehicle, comprising:
the trunk door is divided into two parts as a first sub-door and a second sub-door which are configured to be rotated;
a first rotary shaft of the first sub-door is rotatably installed on the vehicle body and
a second rotary shaft installed between the first sub-door (and the second sub-door are installed in parallel; and
the second sub-door includes a vehicle door lock and is installed to be rotated about the first sub-door.

2. The trunk door of claim 1, wherein the first sub-door and the second sub-door are installed to rotate in the same direction or installed to rotate in directions opposite to each other.

3. The trunk door of claim 1, which is vertically opened or closed in a hatchback manner and operates according to the following order:
(1) the first and second sub-doors are opened together;
(2) only the second sub-door is turned in a direction opposite to a direction in (1); and
(3) the first and second sub-doors are opened in the opening direction in (1).
